(19) United States
(12) Patent Application Publication
(10) Pub. No.: US 2003/0127329 A1
(43) Pub. Date: Jul. 10, 2003

(54) Field effect flow control apparatus for microfluidic networks

(76) Inventors: Donald Lad DeVoe, Bethesda, MD (US); Cheng S. Lee, Ellicott City, MD (US)

Correspondence Address: Donald L. DeVoe, 5619 Sonoma Road, Bethesda, MD, 20817, US

(21) Appl. No.: 10/159,914

(22) Filed: Jun. 1, 2002

Related U.S. Application Data
(60) Provisional application No. 60/295,280, filed on Jun. 4, 2001.

(51) Int. Cl. G01N 27/26; G01N 27/447

(52) U.S. Cl. 204/454; 204/451; 204/601

(57) ABSTRACT

One embodiment of the invention relates to a microfluidic apparatus for controlling fluid flow velocity during electroosmotic flow. According to one aspect of the invention, a voltage applied to a gate electrode modulates flow velocity within an associated microchannel, where the gate voltage is separate from any voltage used to induce electroosmotic flow. According to another aspect of the invention, the flow control apparatus combines multiple gate electrodes to control flow in a microfluidic network. According to one embodiment of the invention, the flow control apparatus is fabricated in a planar silicon substrate. According to another embodiment of the invention, the flow control apparatus is fabricated using polymer materials.

### CROSS REFERENECE TO RELATED APPLICATIONS

This application claims priority from U.S. Provisional Patent Application Serial No. 60/295,280, filed Jun. 4, 2001, which is incorporated herein by reference in its entirety.

### BACKGROUND—FIELD OF INVENTION

The invention relates to a system and method for controlling electroosmotic flow in microfluidic circuits.

### BACKGROUND OF THE INVENTION

Microfluidic flow control has been widely demonstrated for tasks such as mixing and reacting reagents, injection or dispensing samples, and bioseparations (1-9). In these systems, precise control of fluid through the networks plays a significant role. Pumping in microfluidic systems has been demonstrated using a number of methods, including integrated or external pressure-generating actuators, electrohydrodynamic methods, and traction-generating traveling surface waves. However, each of these methods suffers from various issues including poor scaling performance to the micro and nano regimes, complex and costly fabrication of disparate materials and components, and difficulties with very large scale integration into complex microfluidic systems. With the growth of 3-D microfluidic systems, where traditional 2-D microchannels are extended into the 3^{rd}dimension, the integration of micropumps into such increasingly complex microfluidic systems is a critical challenge. In contrast to other methods for flow control in microfluidic systems, EOF is a simple and elegant approach which has been widely used in simple 2-D fluidic systems. Fluid flow in many microfluidic circuits is driven by electroosmotic flow (EOF), particularly for systems involved in electrophoretic separations. EOF offers a number of important advantages for these systems, such as ease of fabrication, simple implementation, the absence of moving parts, and plug-like velocity profiles. Furthermore, EOF flow velocity is independent of channel dimensions even for submicron channels (10), making EOF very attractive for microchannel and nanochannel flow control.

However, the extension of EOF pumping to complex microfluidic systems is limited by the fact that the electrical fields required to induce EOF in multiple interconnected microchannels interact with one another. Modifying a voltage to control fluid flow through a given channel will alter the flow through all other channels in electrical and fluidic contact with the given channel. A technology capable of providing individual control over EOF velocities in interconnected microchannels, without changing the electrical fields within the channels, would open the use of EOF as a preferred method of fluid manipulation within complex 2-D and 3-D microfluidic systems.

In general, EOF describes a particular form of bulk fluid motion within a capillary which occurs, for example, during capillary electrophoresis. A stagnant double layer of solute/solvent occurs adjacent to the liquid/solid interface at the interior wall surface of the capillary during EOF. An excess of charge occurs at the wall surface due to ionization of surface functional groups, creating a potential across the double layer termed the zeta potential. The zeta potential governs the fluid flow velocity within the capillary. A number of ways to change the zeta potential have been explored, including altering the surface chemistry of the capillary wall, the pH of the buffer solution, the buffer concentration, or additives to the buffer solution.

Alternatively, a method for electrical control over the zeta potential has been described in prior art. This technique is here called field-effect flow control (FEFC). Application of field-effect flow control for manipulating the velocity of EOF in capillary electrophoresis has been demonstrated by several groups. The approach involves the use of a radial electric potential gradient across the capillary wall for direct control of the zeta potential at the capillary/solution interface. The radial electric field is created by applying a gate voltage to the outer surface of the capillary. This technique is analogous to an electrical metal-oxide silicon field-effect transistor (MOSFET), in which the gate voltage within the transistor modulates electrical current through the channel region of the transistor. This approach provides control over the zeta potential without requiring changes to the capillary surface properties or to the buffer solution. A radial electric field orthogonal to the longitudinal electrophoresis separation field within the fluid in a silica capillary tube has been previously employed (1). The radial field is created by a high voltage applied to a fluid within a second capillary tube surrounding the separation tube. By using a similar buffer solution in both tubes, the radial electric field is held the same at each point along the tube length, providing the same control over the zeta potential within the separation capillary along the entire tube length. The same concept is described in U.S. Pat. No. 5,151,164, to Blanchard and Lee, with the technique extended to include application of a non-aqueous conductive member surrounding the capillary tube. Similar techniques are described in U.S. Pat. Nos. 5,282,942 to Herrick and Sternberg, 5,320,730 to Ewing, Hayes, and Kheterpal, 5,180,475 to Young, McManigill, and Lux, 5,262,031 to Lux, Swedberg, Young, and McManigill, and 5,092,972 to Ghowsi. In each of these cases, a conductive layer is applied to the outside of a capillary tube to affect the zeta potential at the capillary/solution interface. Similarly, U.S. Pat. Nos. 5,322,607 to Baer and 5,240,584 to Baer employ a resistive coating rather than a pure conductor to control the zeta potential internal to a fused silica capillary. The resistive coating allows separate voltage gradients internal and external to the channel during electrophoresis. A related concept is described in U.S. Pat. No. 5,582,701 to Geis, which uses individual external gate electrodes to induce local charge within the channel which can be moved to subsequent gate electrodes to pump fluid within a capillary. Each of the aforementioned concepts relates to the use of field-effect flow control in silica capillary tubes, with either an aqueous or non-aqueous conductive or resistive material applied to one or more regions of the outer wall of the separation tube. The inventions use the relatively thick capillary tube wall as a dielectric medium across which the electric field is applied, thus requiring large voltages due to the small electrical capacitance of the tube wall. In addition, these inventions are not applicable to microchannels formed in a substrate such as silicon, glass, or plastic.

Rather than directly controlling flow via EOF, an alternate approach is to induce hydraulic pumping by coupling an EOF pump channel to a flow channel through which pumping is desired. For such indirect pumping, EOF is used to generate a pressure gradient along the flow channel, rather than directly creating EOF flow within the channel. This allows an additional level of flow control for systems in which direct EOF control is either not desirable or difficult to implement, such as 3-D microfluidic networks and nanofluidic systems. The FEFC technique described herein offers a unique approach for controlling indirect EOF flow in microchannel circuits.

Unlike EOF, pressure-driven hydraulic flow in small channels exhibits a well-characterized parabolic velocity profile, with the average velocity proportional to the square of the channel's diameter or width for a given pressure gradient. As a result, large pressures are required to pump fluids in small channels, and Taylor dispersion due to axial concentration gradients results in undesirable mixing. However, despite these drawbacks, hydraulic pumping implemented using electroosmotic actuation offers great promise for flow control in microfluidic systems. Because EOF scales very favorably to microchannels, EOF pumping at the microscale can create the high pressure gradients required for hydraulic pumping through both microscale and nanoscale channels. The concept of coupling EOF micropumps to induce hyraulic flow within coupled microchannels offers an elegant solution to the problems associated with direct EOF pumping. In order to generate hydraulic pumping via EOF, two regions with different electroosmotic flows must be formed within the microchannel. As a result of this differential flow, a pressure gradient will be formed between the regions with higher and lower flow. Thus, a microchannel with high EQF flow can be coupled to a channel with low EOF flow, with the high flow microchannel generating net hydraulic pumping through the low flow channel. The challenge in implementing EOF-based pumping lies in forming the required regions of differential electric field. To this end, several groups have investigated the use of salt-bridge junctions to apply electrical voltages at selected points along a flow channel (12-14). Salt-bridges enable electrical interconnection, while limiting bulk fluid leakage. The bridge itself is typically formed by creating a microscale fluid connection between the flow channel and a secondary channel where the gating voltage is applied. For example, Ramsey et al. (12) demonstrated a salt-bridge junction in a glass microchip to provide electrical connection between a flow microchannel and a gating microchannel. By applying a grounding voltage in the gating microchannel and an EOF-inducing voltage at the lower end of the flow microchannel, a voltage gradient along the pump region is created, while the upper region of the flow microchannel is not subject to any electric field. The result is that EOF flow induced in the pump section creates hydraulic flow throughout the entire flow microchannel, thus pumping fluid in the upper field-free section of the channel. A similar result was demonstrated by Guijt et al., in which the required fluidic interconnect was created by imperfect bonding between two substrates defining the channels (13). In a related approach, Takamura et al. (14) fabricated an EOF-based micropump using multiple pairs of salt-bridges between alternating wide and narrow microchannels placed in series. Because the pressure head produced by EOF in small channels is, to first order, inversely proportional to the square of the microchannel diameter (15), the higher pumping efficiency in the narrow channels creates a net pressure buildup along the full length of the cascaded microchannels. By using multiple pairs of wide and narrow channels, large pressure heads up to 5 kPa were demonstrated with relatively low voltages of 40V.

While salt-bridge interconnect technology solves the need for control over electrical potentials at specific points along a microchannel, it also introduces significant new problems. One key problem is poor pumping efficiency resulting from fluid leakage through the bridge. For example, in the work of Ramsey et al. (12), pumping efficiencies between 0.43 and 0.63 were achieved, indicating that as much as 57% of the volume flow in the pump is due to leakage past the salt-bridge junction. For a pumping element generating a positive pressure on a microchannel, this implies significant dilution of the fluid (and any biomolecules) within the microchannel, and the potential for unwanted mixing of multiple solutions. Another problem lies with difficulties in routing the required salt-bridge interconnection channels in complex microfluidic systems. Because the interconnect channels are fabricated in the same substrate as the pumping channels and flow channels, flexibility in channel routing is very limited. A more general problem is that each salt-bridge interconnect requires a separate, large fluidic reservoir for making electrical contact, filled with sufficient buffer solution to prevent depletion of the reservoir due to bridge leakage. This complicates device design and preparation/handling, while increasing the overall system size and complexity. Furthermore, the salt-bridge approach is currently limited to silicon and glass substrates. The use of polymers for microfluidic systems has recently seen a strong increase in demand for a range of biochemical analyses and other biofluidic applications, in particular for low-cost disposable systems. Practical implementation of the required bridge geometry is likely to prove difficult in polymer-based microfluidic systems due to fabrication constraints. Another disadvantage of salt-bridge technology is that as the dimensions of the flow channel shrink, the resistance in the flow channel will become significantly larger than the flow resistance in the salt-bridge interconnect. This characteristic leads to extremely poor pumping efficiency and high leakage through the interconnect for small channel pumping. To avoid the difficulties associated with salt-bridge interconnects, Ramsey et al. replaced the salt bridges with metal electrodes integrated directly into the flow channels fabricated on a glass substrate (16). While EOF control was successfully demonstrated using this approach, the direct electrical interface between the metal electrodes and microchannel fluids resulted in gas generation due to electrolysis. To allow the resulting gas to escape, the glass microchannels must be sealed using a gas-permeable polymer membrane layer, which presents a significant constraint on the system. In contrast, the FEFC technology is applicable to both direct EOF pumping and indirect EOF pumping while simultaneously avoiding the pitfalls of fluid leakage with salt-bridge junctions and electrolysis with integrated electrodes. The FEFC concept sidesteps these problems entirely, by eliminating the salt-bridge interconnect and providing control over fluid flow rate and direction without direct electrode/fluid contact.

Compared to prior art using silica capillary tubes, field-effect flow control in microchannels has received relatively little attention. Work described by van der Berg (17) extends capillary field-effect flow control to a silicon-based microchannel platform. The microchannels are formed from a thin film of silicon nitride deposited in etched regions of a silicon wafer substrate. The silicon wafer is bonded to a glass layer, and the silicon is selectively etched away, leaving fragile silicon nitride channels bonded to the glass layer. By metalizing the outer walls of the channel, the zeta potential within the wall/solution interface may be modulated. One reason for removal of the silicon layer is to eliminate electrical cross-talk between individual field-effect gate voltages. The result of this requirement is that the microchannel walls are subject to breakage due to their lack of mechanically robustness. In addition, the materials which may be used to create the microchannels are limited by the need for compatibility with the silicon-on-glass bonding process. Furthermore, there is no process in the literature which is compatible with the application of FEFC to polymer-based microfluidic systems, which has become an increasingly important commercial technology.

### SUMMARY OF THE INVENTION

One object of the invention is to overcome these an other drawbacks in existing systems and methods.

A microchannel field-effect flow control apparatus includes a planar substrate containing at least one microchannel. The microchannel consists of a length, a cross section, an inlet, and an outlet. The inlet and outlet are connected to a first and second reservoir at either end of the microchannel. Alternately, the microchannel may terminate at other microchannels fabricated into the planar substrate. A first power supply applies a separation potential along the length of the microchannel between the first and second reservoir. The substrate contains a conductive gate region which surrounds at least one side of the microchannel along a portion of the microchannel length. The gate region is electrically isolated from other gate regions which may exist on the same substrate. A dielectric layer is placed between the conductive region of the substrate and the fluid filled microchannel. A second power supply applies a voltage to the conductive gate, resulting in a flow-control potential between the gate and fluid within the microchannel.

In its simplest embodiment, the FEFC technology requires four separate layers, although designs with more or fewer layers are also possible. A bottom polymer substrate provides mechanical rigidity and contains integrated metal electrodes for applying field-effect gate voltages. The top polymer layer contains the desired microscale flow channels and microfluidic EOF pumping channels. In between the top and bottom layers is a thin polymer film used as a gate dielectric in the FEFC pump, which also isolates the electrodes from the fluid in the channels to prevent electrolysis. In an ideal FEFC micropump, control over the ζ potential on all four sides of the microchannel is desirable to ensure equal flow rates for fluid near each of the channel walls. Unequal flow rates resulting from different ζ potentials may lead to unwanted skewing of the flat plug flow typically observed in EOF pumping. Because some fabrication processes described here only provides control over one of the four channel walls, some skewing of the flow profile might be expected. However, studies by Hayes and Ewing on FEFC in capillary-based systems (20,21) suggest that the charge induced by the radial FEFC voltage in a small section of a capillary is dispersed over a larger region of the unsheathed capillary through conductance of the solution within the electrical double layer at the channel walls. This phenomena effectively extends the ζ potential control provided by the single electrode at the bottom of the microchannelto the entire circumference of the channel, obviating the need for voltage control along all four channel walls.

In one embodiment, rigid polycarbonate (PC) may be used for the bottom polymer substrate. PC is an excellent choice for this application due to its low cost, high stiffness, relatively high fracture toughness, and thermal stability up to temperatures approaching 160° C. FEFC electrodes are formed from 500 nm thick gold, with a thin adhesion layer of chromium. Both metals are deposited by evaporation, and patterned using chemical etchants. PC provides excellent chemical resistance to the Cr/Au acidic etchants and is not damaged during the electrode etching. Another advantage of PC lies in the low optical attenuation at wavelengths of interest for fluorescence detection. Furthermore, it is possible to fabricate microchannels directly into PC using hot embossing, injection molding, or laser ablation. Silicon and glass may also be used as alternative materials for the microfluidic substrate layers, among other possible materials.

A dielectric layer is required between the metallized substrate and the polymer layer containing the flow channels. Sealing of the channels may be achieved using a flexible layer of poly(dimethylsiloxane) (PDMS), using a polymer lamination film, or through direct thermal bonding with a second polycarbonate substrate, for example. Depending on the choice of FEFC polymer, one bonding method may prove to be more effective than the others. Metallization, microchannel fabrication, and polymer bonding using soft plastics such as PDMS has been extensively demonstrated on silicon and glass substrates. The disadvantages of these materials reside in their relatively high cost and poor fracture toughness.

A critical material in the microfluidic system is the dielectric layer used to separate the gate electrode from the microchannels for FEFC. For silicon-based FEFC devices, both silicon nitride and silicon dioxide have been successfully demonstrated for limited applications (18,19). However, for the polymer-based FEFC technology, a polymer dielectric material is required for compatibility with fabrication constraints and system requirements. Key requirements for this dielectric layer include controllable and repeatable thickness, low defect density, chemical and biochemical compatibility, and simple deposition for cost-effective manufacturing. In addition, the appropriate material should have a large breakdown strength coupled with a large dielectric constant. A good metric for the performance of any FEFC configuration is given by the product of the maximum acheivable voltage and capacitance of the channel wall dielectric, which is proportional to E_{bd}εᵣ. Here, E_{bd} is the maximum breakdown field and εᵣ is the relative permittivity of the dielectric material. Several polymer dielectric thin film materials that meet these material requirements are available, such as Parylene C, PDMS, Teflon, Pyralin, Cyclotene BCB, and PTFE, among others. Each of these materials may be depositied by either spin-on techniques or physical vapor deposition to form thin films on semi-planar substrates.

### BRIEF DESCRIPTION OF THE DRAWINGS

FIG. 1 is a schematic of capacitive divider formed between the applied bias voltage, zeta potential, and microchannel bias voltage during field-effect flow control.

FIG. 2A is a cross sectional view of a silicon-based field-effect flow control apparatus with a doped-silicon gate electrode.

FIG. 2B is an overhead view of a silicon-based field-effect flow control apparatus with a doped-silicon gate electrode.

FIG. 3 is a cross sectional view of a silicon-based field-effect flow control apparatus with a deposited gate electrode.

FIG. 4 is a cross sectional view of a silicon-based field-effect flow control apparatus with a deposited gate electrode and an alternate microchannel geometry.

FIG. 5 is a generic field-effect flow control apparatus with an internal gate electrode.

FIG. 6 is a generic field-effect flow control apparatus with an external gate electrode.

### DETAILED DESCRIPTION OF THE INVENTION

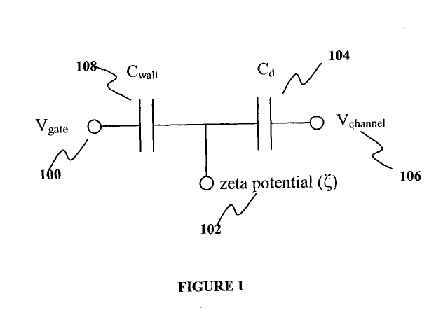

According to an aspect of the invention, depicted schematically in FIG. 1, a gate control voltage V_{gate} 100 applied at a gate electrode modifies the zeta potential 102 within a microchannel by acting through a capacitive voltage divider network consisting of a capacitor C_{d} 104 is formed across the electrical double layer between the zeta potential at the microchannel wall and the bias voltage V_{channel} 106 within the bulk fluid of the microchannel. The gate control voltage is applied across a capacitor C_{wall} 108 formed by a dielectric layer separating the zeta potential from V_{gate}. By varying the gate voltage, the capacitive divider formed by C_{wall} and C_{d} result in modulation of the zeta potential (ζ) through the following approximate relationship: Δζ=(C_{wall}/C_{d})V_{gate}.

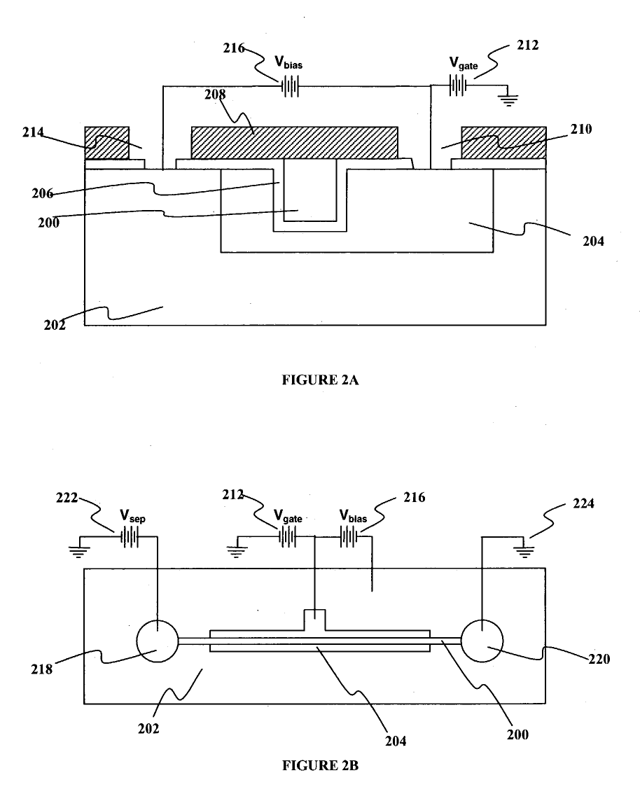

According to an embodiment of the invention illustrated in FIG. 2A, a field-effect flow control apparatus using a doped silicon electrode in a silicon substrate is provided. FEFC apparatus may comprise a microchannel 200 in a planar silicon substrate 202 which may be doped with a p-type dopant. A selected gate region 204 of the silicon surrounding the microchannel may be heavily doped with an n-type dopant. A p-n diode junction is thereby formed between the p-type substrate and n-type gate region. In some preferred aspects, the substrate material may be formed from n-type silicon, with the gate region selectively doped with a p-type dopant. In either case, reverse biasing the p-n junction will prevent significant current leakage between the gate and substrate, providing electrical isolation between multiple gate regions in a single substrate. A thin insulating dielectric layer 206 is formed on the surface of the microchannel. This dielectric layer may be grown directly within the channel region, for example by selective electrodeposition or vapor deposition of a polymer before or after sealing the microchannel, or it may be deposited along the entire surface of the substrate including the exposed microchannel surfaces. A variety of materials may be employed as the dielectric layer. Typically, the dielectric layer will be selected based on compatibility with the microfabrication process, with the fluid and biological molecules within the fluid, and with the range of conditions to which the dielectric layer will be exposed such as variations in pH, temperature, salt concentration, radial and longitudinal electric field, etc. Typical material choices may include silicon dioxide, silicon nitride, a variety of polymers, etc. A sealing layer 208 prevents fluid from escaping from the top of the microchannel. The sealing layer may be a bonded silicon, glass, or rigid plastic substrate. Alternately, the sealing layer may be fabricated using a polymer film, such as poly(dimethylsiloxane) (PDMS), or a laminated plastic film. As with the dielectric layer, selection of the sealing layer material will depend on compatibility with the microfabrication process, compatibility with the fluid and biological molecules within the fluid, and compatibility with the range of conditions to which the dielectric layer will be exposed. A first hole in the sealing layer 210 allows the connection of a power supply 212 to the gate for application of a gate voltage, V_{gate}. A second hole in the sealing layer 214 allows the connection of a power supply 216 to the non-gate region of the substrate for application of a bias voltage to the substrate, V_{bias}. The bias voltage is selected to maintain a small reverse bias across the p-n junction between the gate and substrate regions. The holes are formed by either removing material from the sealing layer and insulating layer after integration of each layer into the overall system, or by patterning each layer prior to their integration. The mechanisms for patterning depend on the material choice for each layer, e.g. wet hydrofluoric acid etching of a silicon dioxide insulating layer, hot phosphoric acid etching of a silicon nitride insulating layer, micromolding of a PDMS sealing layer, or similar technique. While it is understood that this invention applies to systems of multiple and potentially interconnected microchannels, an apparatus with a single microchannel is depicted in FIG. 2B for clarity of description. One end of the microchannel is connected to a first reservoir 218. The reservoir is typically fabricated in the sealing layer, but may also be fabricated in the substrate with an access port placed in the sealing layer to allow fluid to be supplied to or removed from the reservoir. The other end of the microchannel is connected to a second reservoir 220. A power supply 222 used to generate a separation potential along the. length of the microchannel is placed into contact with fluid in the first reservoir using an external electrode. In another embodiment, a thin film metal electrode integrated into the microfluidic system may be used to form an electrical connection between the power supply and fluid within the microchannel. A similar electrical connection 224 is made to the second reservoir to provide a grounding path for the separation potential.

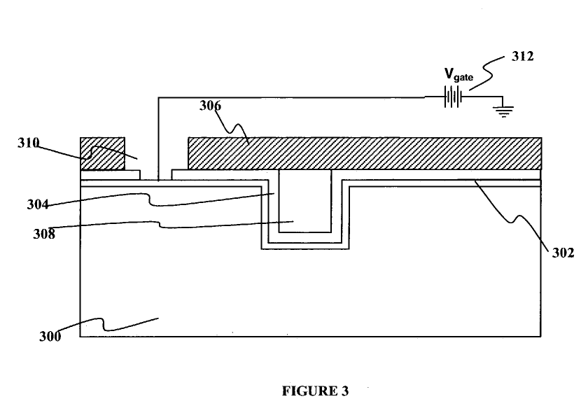

An additional embodiment is shown in FIG. 3. In this case, a substrate 300 is formed from an insulating or high-resistivity material, for example a rigid or flexible plastic, or undoped silicon. A conductive layer 302 is deposited over the substrate. The conductive electrode layer may be selectively deposited over a specified region of the substrate, for example by using a shadow mask during evaporation or sputtering of a metallic thin film, or deposited over the entire substrate and removed from regions where it is not desired, for example by using photolithography and etching of the unwanted electrode material. An insulating layer 304 is deposited on top of the conductive electrode. The insulating layer may be formed from a number of materials, for example an electrodeposited or vapor-deposited polymer. A sealing layer 306 is applied to the top surface of the substrate, enclosing a microchannel 308. A hole 310 opens the sealing layer and insulating layer to provide a means for electrical connection to the conductive layer 302. The conductive layer acts as a gate electrode, and a gate voltage 312 is applied to the electrode in order to modulate the zeta potential within the channel.

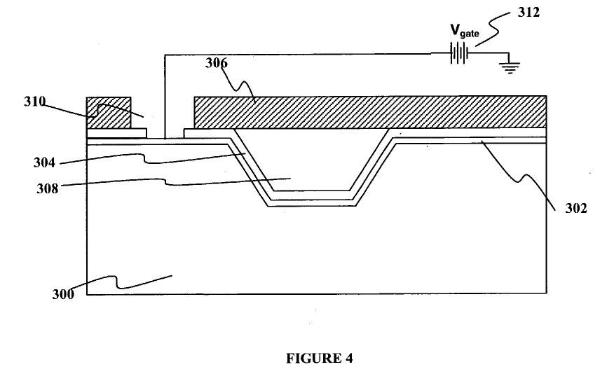

In another aspect of the invention, there are various possibilities with regard to the geometry of the substrate, gate electrode, insulating layer, and sealing layer. FIG. 4 depicts a field-effect flow control microchannel device with sloped channel sidewalls. These sidewalls could be produced by using bulk-etched silicon as the substrate material, by using a bulk-etched silicon template as a mold for embossing a sloped microchannel feature into a rigid plastic substrate (such as polycarbonate), or by using a bulk-etched silicon template as a mold for forming a sloped microchannel feature in an in-situ polymerizable plastic (such as PDMS).

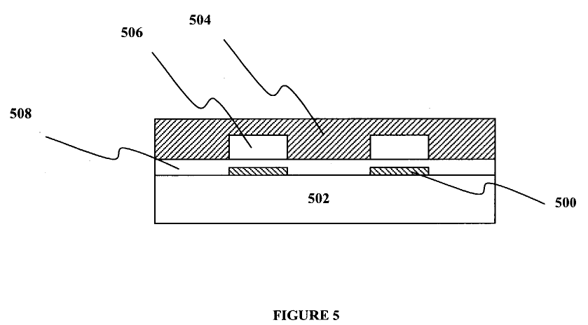

According to one embodiment, as illustrated in FIG. 5, the apparatus may comprise one or more gate electrodes 500 positioned in between a first insulating planar substrate 502 and a second planar substrate containing one or more microchannels 506. A gate dielectric layer 508 may be included to prevent direct electrical connection between the gate electrodes and fluid within the microchannels. In this embodiment, there is considerable freedom in the choice of materials for the various components of the apparatus. The substrate materials may be rigid plastic, soft plastic, silicon, glass, or similar material. Furthermore, the gate electrodes may be thin film metal, metal foil, conductive epoxy, conductive polymer, metal wire, conductive ink, or other conductive material. Furthermore, the gate dielectric layer may be a spin-on polymer such as PDMS, a vapor-deposited polymer such as Parylene, or another material which may be readily applied to the substrate and which preferably provides a high dielectric constant and electrical breakdown strength. Furthermore, based on the choice of substrate material, the methods available for fabrication of the microchannels are also considerable. For example, microchannels may be fabricated in a polymer substrate (such as polycarbonate or acrylic) using hot embossing or injection molding techniques. Similarly, chemical etching may be used to fabricate microchannels in a glass substrate which may then be bonded to the gate dielectric film.

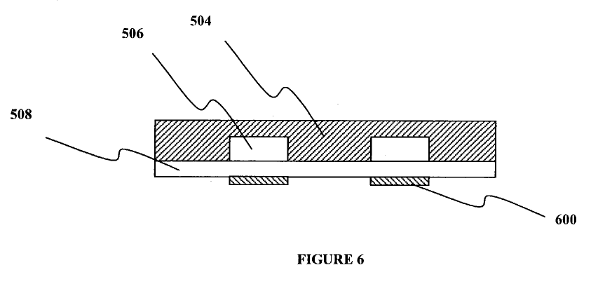

According to one embodiment, as illustrated in FIG. 6, the apparatus may comprise one or more gate electrodes 600 positioned on the exterior surface of a first insulating planar substrate. In this embodiment, the substrate acts as the gate dielectric layer.

Other embodiments, uses, and advantages of the invention will be apparent to those skilled in the art from consideration of the specification and practice of the invention disclosed herein. The specification should be considered exemplary only, and the scope of the invention is accordingly intended to be limited only by the following claims.

Litereature Cited

1. D. J. Harrison, A. Manz, Z. Fan, H. Ludi, H. M. Widmer, “Capillary Electrophoresis and Simple Injection Systems Integrated on a Planar Glass Chip”, Anal. Chem., 64, 1926 (1992).

2. D. J. Harrison, K. Fluri, K. Seiler, Z. Fan, C. S. Effenhauser, A. Manz, “Micromachining a Miniaturized Capillary Electrophoresis-Based Chemical Analysis System on a Chip”, Science, 261, 895 (1993).

3. N. Chiem, D. J. Harrison, “Microchip-Based Capillary Electrophoresis for Immunoassays”, Anal. Chem., 69, 373 (1997).

4. C. S. Effenhauser, A. Manz, H. M. Widmer, “Glass Chips for High-Speed Capillary Electrophoresis Separations with Submicrometer Plate Heights”, Anal. Chem., 65, 2637 (1993).

5. C. S. Effenhauser, A. Manz, H. M. Widmer, “Manipulation of Sample Fractions on a Capillary Electrophoresis Chip”, Anal. Chem., 67, 2284 (1995).

6. S. C. Jacobson, R. Hergenroder, L. B. Koutny, R. J. Warmakc, J. M. Ramsey, “Effects of Injection Schemes and Column Geometry on the Performance of Microchip Electrophoresis Devices”, Anal. Chem., 66, 1107 (1994).

7. L. C. Waters, S. C. Jacobsen, N. Krotchinina, J. Khandurina, R. S. Foote, J. M. Ramsey, “Microchip Device for Cell Lysis, Multiplex PCR Amplification, and Electrophoresis Sizing”, Anal. Chem., 70, 158 (1998).

8. T. Woolley, R. A. Mathies, “Ultrahigh Speed DNA Sequencing Using Capillary Electrophoresis Chip”, Anal. Chem., 67, 3676 (1995).

9. T. Woolley, G. F. Sensabaugh, R. A. Mathies, “High Speed DNA Genotyping Using Microfabricated Capillary Array Electrophoresis Chips”, Anal. Chem., 69, 2181 (1997).

10. R. J. Hunter, Zeta Potential in Colloid Science: Principles and Applications, Academic Press, New York (1981).

11. C. S. Lee, W. C. Blanchard, C. T. Wu, “Direct Control of the Electroosmosis in Capillary Zone Electrophoresis by Using an External Electric Field”, Anal. Chem., 62, 1550 (1990).

12. J. P. Alarie, S. C. Jacobson, B. S. Broyles, T. E. McKnight, C. T. Culbertson, J. M. Ramsey, “Electroosmotically Induced Hydraulic Pumping on Microchips”, Proc. MicroTAS '01, pp.131 (2001).

13. R. M. Guijt, J. Lichtenberg, E. Baltussen, E. Verpoorte, N. F. de Rooij, G. W. K. van Dedem, “Indirect Electro-osmotic Pumping for Direct Sampling from Bioreactors”, Proc. MicroTAS '01, pp. 399 (2001).

14. Y. Takamura, H. Onada, H. Inokuchi, S. Adachi, A. Oki, Y. Horiike, “Low-Voltage Electroosmotic Pump and its Application to on-chip Linear Stepping Pneumatic Pressure Source,” Proc. MicroTAS '01, pp.230 (2001).

15. P. H. Paul, D. W. Arnold, D. W. Neyer, K. B. Smith, “Electrokinetic Pump Application in Micro-Total Analysis Systems Mechanical Actuation to HPLC”, Proc. MicroTAS '00, pp 583 (2000).

16. T. E. McKnight, C. T. Culbertson, S. C. Jacobson, J. M. Ramsey, “Electroosmotically Induced Hydraulic Pumping with Integrated Electrodes on Microfluidic Devices”, Anal. Chem., 73, 4045 (2001).

17. van der Berg et al., “Field-Effect Flow Control for Microfabricated Fluidic Networks”, 1999, vol. 286, pp. 942.

18. R. B. M. Schasfoort, S. Schlautmann, J. Hendrikse, A. van den Berg, “Field-Effect Flow Control for Microfabricated Fluidic Networks”, Science, 286, 942 (1999).

19. N. J. Sniadecki, P.-C. Wang, C. S. Lee, D. L. DeVoe, “A Silicon Microfluidic Multiplexer Using Field Effect Flow Control,” Proc. MicroTAS '01, pp. 187 (2001).

20. Hayes, M., Ewing, A. G., “Electroosmotic Flow Control and Monitoring with an Applied Radial Voltage for Capillary Zone Electrophoresis,” Anal. Chem., 64, 512 (1992).

21. Hayes, M., Kheterpal, I., Ewing, A. G., “Electroosmotic Flow Control and Surface Conductance in Capillary Zone Electrophoresis,” Anal. Chem., 65, 2010 (1993).

22.

Other Embodiments

Although particular embodiments have been disclosed here in detail, this has been done by way of example for purposes of illustration only, and is not intended to be limiting with respect to the scope of the appended claims, which follow. In particular, it is contemplated by the inventors that various substitutions, alterations, and modifications may be made to the invention without departing from the spirit and scope of the invention as defined by the claims. Other aspects, advantages, and modifications are considered to be within the scope of the following claims.

We claim:

1. A microfluidic apparatus for controlling fluid flow velocity, the apparatus comprising:
at least one planar substrate;
at least one microchannel fabricated within the planar substrate;
at least one gate electrode;
at least one gate dielectric layer separating the gate electrode from the fluid within the microchannel;
means for applying a longitudinal electric field within the fluid along the length of the microchannel;
means for applying a voltage to the gate electrode.

2. The apparatus of claim 1 wherein the one or more gate electrodes comprise thin film metal.

3. The apparatus of claim 1 wherein the one or more gate electrodes comprise thin film metal deposited by a common method such as evaporation or sputtering and patterned by photolithography and etching of the thin film.

4. The apparatus of claim 1 wherein the one or more gate electrodes comprise heavily-doped silicon.

5. The apparatus of claim 1 wherein the one or more gate electrodes comprise metal foil.

6. The apparatus of claim 1 wherein the one or more gate electrodes comprise conductive polymer.

7. The apparatus of claim 1 wherein the one or more gate electrodes comprise electrically-conductive wire.

8. The apparatus of claim 1 wherein a nonconducting gate dielectric film is located between the gate electrodes and a planar substrate containing the one or more microchannels.

9. The apparatus of claim 1 wherein the first planar substrate comprises single-crystal silicon, the microchannels are etched into the silicon substrate, the gate electrode comprises heavily-doped single-crystal silicon, the gate dielectric layer comprises thin film silicon dioxide, and the second planar substrate comprises a sealing layer which encloses at least a portion of the one or more microchannels.

10. The apparatus of claim 1 wherein the first planar substrate comprises single-crystal silicon, the microchannels are etched into the silicon substrate, the gate electrode comprises heavily-doped single-crystal silicon, the gate dielectric layer comprises thin film silicon nitride, and the second planar substrate comprises a sealing layer which encloses at least a portion of the one or more microchannels.

11. The apparatus of claim 1 further comprising first and second planar substrates, wherein the gate electrodes and gate dielectric layer are placed on the top of the first planar substrate, microchannels are formed on the bottom of the second planar substrate, and the top of the first substrate is attached to the bottom of the second substrate to seal the microchannels.

12. The apparatus of claim 11 wherein the first and second planar substrates comprise glass.

13. The apparatus of claim 11 wherein the first and second planar substrates comprise plastic.

14. The apparatus of claim 11 wherein the first and second planar substrates comprise polycarbonate plastic.

15. The apparatus of claim 11 wherein at least one of the planar substrates comprises poly(dimethylsiloxane) (PDMS).

16. The apparatus of claim 11 wherein the first and second planar substrates comprise a combination of dissimilar materials.

17. The apparatus of claim 11 wherein the gate dielectric layer comprises a spin-on polymer.

18. The apparatus of claim 11 wherein the gate dielectric layer comprises poly-poly(dimethylsiloxane) (PDMS).

19. The apparatus of claim 11 wherein the gate dielectric layer comprises a vapor-deposited polymer.

20. The apparatus of claim 11 wherein the gate dielectric layer comprises vapor-deposited Parylene.

21. The apparatus of claim 11 further comprising first and second planar substrates, wherein the gate electrodes are placed on the bottom of the first planar substrate, microchannels are formed on the bottom of the second planar substrate, and the top of the first substrate is attached to the bottom of the second substrate to seal the microchannels, with the first planar substrate acting as the gate dielectric layer.

22. The apparatus of claim 21 wherein the first and second planar substrates comprise glass.

23. The apparatus of claim 21 wherein the first and second planar substrates comprise plastic.

24. The apparatus of claim 21 wherein the first and second planar substrates comprise polycarbonate plastic.

25. The apparatus of claim 21 wherein at least one of the planar substrates comprises poly-poly(dimethylsiloxane) (PDMS).

26. The apparatus of claim 21 wherein the first and second planar substrates comprise a combination of dissimilar materials.

27. The apparatus of claim 21 wherein the gate dielectric layer comprises a spin-on polymer.

28. The apparatus of claim 21 wherein the gate dielectric layer comprises poly-poly(dimethylsiloxane) (PDMS).

29. The apparatus of claim 21 wherein the gate dielectric layer comprises a vapor-deposited polymer.

30. The apparatus of claim 21 wherein the gate dielectric layer comprises vapor-deposited Parylene.

31. The apparatus of claim 1 wherein at least one inlet reservoir is in fluid communication with a first end of at least one of the microchannels, and an outlet reservoir is in fluid communication with a second end of at least one of the microchannels.

32. The apparatus of claim 1 wherein the one or more microchannels form an interconnected microfluidic network, with one or more gate electrode positioned adjacent to each of the one or more microchannels.

33. A method of controlling fluid flow velocity within a microchannel, the method comprising the steps of:
Providing the apparatus of claim 1;
applying a fixed longitudinal electric field along the microchannel length;
applying a gate voltage to the one or more gate electrodes to achieve the desired flow velocity.

34. The method of claim 33 wherein the flow velocity if measured in real-time, and a closed-loop feedback system is used to modify the gate voltage automatically to achieve the desired flow velocity.

35. The method of claim 34 wherein flow velocity measurement system comprises a conductometric detection system.

36. The method of claim 34 wherein flow velocity measurement system comprises an optical detection system.

37. The method of claim 34 wherein flow velocity measurement system comprises an integrated optical detection system.

38. The method of claim 34 wherein flow velocity measurement system comprises a laser induced fluorescence detection system.
